(19) United States
(12) Patent Application Publication
(10) Pub. No.: US 2022/0043455 A1
(43) Pub. Date: Feb. 10, 2022

(54) PREPARING ROBOTIC OPERATING ENVIRONMENTS FOR EXECUTION OF ROBOTIC CONTROL PLANS

(71) Applicant: X Development LLC, Mountain View, CA (US)

(72) Inventor: Adam Nicholas Ruxton, Sunnyvale, CA (US)

(21) Appl. No.: 16/987,948

(22) Filed: Aug. 7, 2020

(51) Int. Cl. G05D 1/02

(52) U.S. Cl. CPC G05D 1/0248

(57) ABSTRACT

Methods, systems, and apparatus, including computer programs encoded on computer storage media, for executing a robotic control plan in a robotic operating environment. One of the methods includes: obtaining, by a mobile automation setup device, sensor data characterizing a robotic operating environment that comprises one or more assembly components; providing, by the mobile automation setup device, the sensor data to a robotic planning system; receiving, by the mobile automation setup device from the robotic planning system, a robotic control plan to be executed by one or more robotic components in the robotic operating environment, wherein the robotic control plan has been generated according to the obtained sensor data; obtaining, by the mobile automation setup device and for each assembly component, a respective initial position of the assembly component in the robotic control plan; and presenting a visual representation of the respective initial position for each assembly component.

### BACKGROUND

This specification relates to robotics, and more particularly to planning robotic movements.

Robotics planning refers to sequencing the physical movements of robotic components in order to perform tasks. For example, an industrial robot that builds cars can be programmed to first pick up a car part and then weld a car part onto the frame of the car. Each of these actions can themselves include dozens or hundreds of individual movements by robot motors and actuators.

Robotics planning has traditionally required immense amounts of manual programming in order to meticulously dictate how the robotic components should move in order to accomplish a particular task. Manual programming is tedious, time-consuming, and error prone. In addition, a plan that is manually generated for one robotic operating environment can generally not be used for other robotic operating environments. In this specification, a robotic operating environment is the physical environment in which a robotic component will operate. Robotic operating environments have particular physical properties, e.g., physical dimensions, that impose constraints on how robotic components can move within the robotic operating environment. Thus, a manually-programmed plan for one robotic operating environment may be incompatible with a robotic operating environment having different physical dimensions.

Robotic operating environments often contain more than one robot. For example, a robotic operating environment can have multiple robotic components each welding a different car part onto the frame of a car at the same time. In these cases, the planning process can include assigning tasks to specific robotic components and planning all the movements of each of the robotic components. Manually programming these movements in a way that avoids collisions between the robotic components while minimizing the time to complete the tasks is difficult, as the search space in a 6D coordinate system is very large and cannot be searched exhaustively in a reasonable amount of time.

### SUMMARY

This specification generally describes how a system can obtain sensor data characterizing a robotic operating environment for which the system does not have sensor data. The system can then generate, according to the sensor data, a robotic control plan for one or more robotic components to accomplish a task within the robotic operating environment. The system can also instruct a user to place one or more assembly components in an initial position within the robotic operating environment so that the robotic components can use during the assembly components during robotic control plan.

Particular embodiments of the subject matter described in this specification can be implemented so as to realize one or more of the following advantages.

Using techniques described in this specification, a system can generate a robotic control plan specific to a “new” robotic operating environment, i.e., an environment for which the system does not have any data and in which the robotic components have not operated before. For example, the robotic operating environment can be a “temporary” robotic operating environment, i.e., an environment in which the robotic components will complete only one or a few tasks. For example, the robotic operating environment can be in a user's home, e.g., in a garage, and the robotic components can be delivered to the user's home to accomplish a particular task, e.g., assembling furniture. Thus, the techniques described in this specification can enable the robust and reliable assembly of complex items in a fully-automated way and in robotic operating environments that are new and/or temporary.

As a particular example, a user might purchase an unassembled piece of furniture, e.g., a desk, from a store. When the store sends the packed assembly components of the desk to the home of the user, the store can also send a mobile automation setup device as described in this specification, and one or a few robotic components. Using techniques described in this specification, the user can use the mobile automation setup device to set up a robotic operating environment for assembling the desk using the robotic components, e.g., in the garage of the home of the user. After the user sets up the robotic operating environment, a robotic control system can instruct the robotic components to assemble the desk. After the assembly is completed, the user can send the mobile setup assistance and robotic components back to the store. In this way, the store can enable customers to automatically assemble purchased furniture in new environments in a time-efficient and cost-efficient manner.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 illustrates an example robotic operating environment.

FIG. 3 is a flowchart of an example process for generating a robotic control plan and preparing a robotic operating environment.

Like reference numbers and designations in the various drawings indicate like elements.

### DETAILED DESCRIPTION

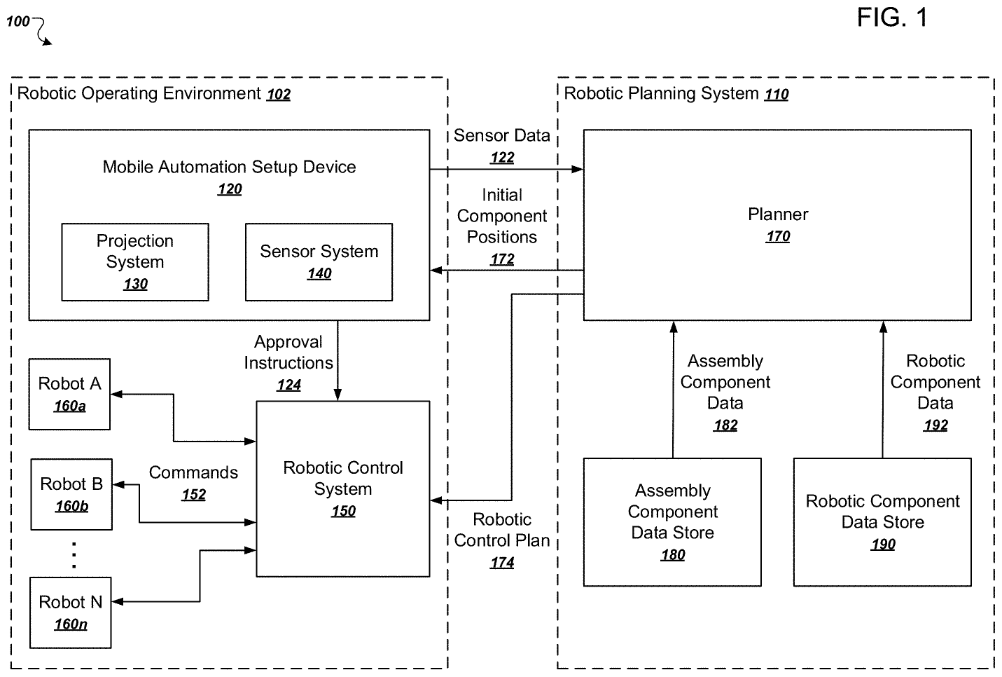

FIG. 1 is a diagram that illustrates an example system 100. The system 100 is an example of a system that can implement the techniques described in this specification.

The system 100 includes a robotic operating environment 102 and a robotic planning system 110. The robotic operating environment 102 includes a robotic control system 150, and the robotic planning system includes a planner 170, an assembly component data store 180, and a robotic component data store 190. Each of these components can be implemented as computer programs installed on one or more computers in one or more locations that are coupled to each other through any appropriate communications network, e.g., an intranet or the Internet, or combination of networks.

The robotic operating environment 102 includes a mobile automation setup device 120. The mobile automation setup device 120 is a device that includes a sensor system 140 and a projection system 130. In some implementations, the mobile automation setup device 120 also includes a user input system, e.g., a voice command system or a graphical display with a touchpad, that obtains user inputs from a user of the mobile automation setup device 120. In some implementations, the components of the mobile automation setup device 120 can be separated between multiple different devices. For example, the sensor system 140 of the mobile automation setup device 120 can be in a first device while the projection system 130 of the mobile automation setup device 120 can be in a second device.

The sensor system 140 includes one or more sensors configured to capture sensor data 122 of the robotic operating environment 102. The sensors in the sensor system 140 can be any type of sensors that can take measurements of a current state of the robotic operating environment 102, e.g., a camera, a lidar sensor, an ultrasonic sensor, or a microphone. In some implementations, there can be multiple sensors in the sensor system 140, where different sensors are of a different type and/or differently configured than the other sensors in the sensor system 140. As a particular example, the sensor system 140 can capture measurements of the robotic operating environment 102 and generate a stereolithography (STL) file that characterizes the geometry of the robotic operating environment.

The system 100 also includes N robotic components 160a-n. The robotic control system 150 is configured to control the robotic components 160a-n. The overall goal of the planner 170 of the robotic planning system 110 is to generate a robotic control plan 174 that allows the robotic control system 150 to execute one or more tasks in the robotic operating environment 102. The tasks in the robotic control plan 174 can include one or more assembly tasks, whereby the robotic components 160a-n manipulate one or more assembly components in order to assemble a final product.

In particular, the mobile automation setup device 120 can capture sensor data 122 characterizing the robotic operating environment 102 and send the sensor data 122 to the planner 170. The planner 170 can use the sensor data 122 to generate a robotic control plan 174 that is specially configured for the robotic operating environment 102. Generally, in order to generate a robotic control plan to be executed in a particular robotic operating environment, the planner 170 requires a near-perfect understanding of the particular robotic operating environment; this understanding is provided by the sensor data 122.

In some implementations, the mobile automation setup device also provides to the planner 170 an identification of one or more tasks to be accomplished by the robotic control plan 174, e.g., an identification of one or more products to be assembled. For example, the mobile automation setup device 120 might obtain a user input identifying the one or more user input, e.g., by a voice command or a barcode scan.

In some implementations, the planner 170 can generate multiple different candidate robotic control plans, each corresponding to a respective initial position for each robotic component 160a-n and assembly component in the robotic operating environment 102. The goal of each candidate robotic control plan is to accomplish the one or more task; however, each candidate plan does not necessarily accomplish the tasks. The initial position in the robotic operating environment 102 of a particular component is a location and orientation of the component in a common coordinate system of the robotic operating environment 102 at which the particular component is placed before execution of the candidate robotic control plan.

For example, the planner 170 can determine, using the sensor data 122, multiple different candidate initial configurations, where each candidate initial configuration defines a particular initial position for each component in the robotic operating environment 102. That is, the planner 170 can determine, for each component in the robotic operating environment 102, an initial position that i) is possible according to the model of the robotic operating environment 102 defined by the sensor data 122 (e.g., the initial position is not in the same location as another object in the robotic operating environment 102) and ii) enables the robotic components 160a-n to complete the one or more required tasks (e.g., the initial location of an assembly component is within reach of a robotic arm that must manipulate the assembly component).

In some implementations, the mobile automation setup device 120 can provide one or more candidate configurations to the planner 170. That is, the mobile automation setup device can process the sensor data 122 to generate the one or more candidate configurations, and provide the candidate configurations along with the sensor data 122.

The planner 170 can then generate one or more candidate robotic control plans corresponding to each candidate initial configuration. Each candidate robotic control plan includes instructions for each robotic component 160a-n to execute movements in order to complete the one or more tasks.

As a particular example, for a particular task, the planner 170 might obtain a template robotic control plan that, independent of the robotic operating environment 102, will enable the robotic components 160a-n to complete the one or more tasks. The template robotic control plan includes a template initial configuration that defines an initial position for each robotic component 160a-n and each assembly component according to a second coordinate system. The planner 170 can then use the template robotic control plan to generate one or more candidate robotic control plans specific to the robotic operating environment 102. For example, the planner 170 might determine a particular three-dimensional volume in the second coordinate system that defines every location that the robotic components 160a-n would occupy if the robotic components 160a-n executed the template robotic control plan. The planner 170 might then determine, using the sensor data 122, one or more volumes of the same size and shape as the particular volume in the robotic operating environment 102. That is, the planner 170 might determine one or more translations of the particular volume to project the particular volume from the second coordinate system to the common coordinate system of the robotic operating environment 102. Each of these translations would define the initial configuration for a respective candidate robotic control plan, with the instructions for the robotic components 160a-n of the robotic control plan being defined by the template robotic control plan.

The planner 170 can select the final robotic control plan 174 from the set of candidate robotic control plans. For example, the planner 170 might assign each candidate robotic control plan a score based on the time required to complete the candidate robotic control plan. In some implementations, the planner 170 considers other factors in addition to time to complete the plan, e.g., a risk of collision during execution of the plan.

In order to generate the robotic control plan 174, the planner 170 can also obtain robotic component data 192 from the robotic component data store 190. The robotic component data 192 characterizes the abilities of the robotic components 160a-n. For example, the robotic component data 192 can include one or more of: design files for each robotic component 160a-n (e.g., CAD files), technical specifications for each robotic component 160a-n (e.g., payload capacity, reach, speed, accuracy thresholds, etc.), robot control simulation (RCS) data (e.g., modeled robot motion trajectories), or APIs for interaction with the robotic control system 150. The APIs can include one or more of sensor APIs (e.g., sensors that measure force, torque, motion, vision, gravity, etc.) or data management interfaces (e.g., product life-cycle (PLC), product life-cycle management (PLM), or manufacturing execution systems (MES) APIs).

In order to generate the robotic control plan 174, the planner 170 can also obtain assembly component data 182 from the assembly component data store 180. The assembly component data 182 characterizes the one or more assembly components that are required to assemble the final products corresponding to one or more of the tasks of the robotic control plan 174. In particular, the assembly component data 182 can define the dimensions of each assembly component, e.g., with a CAD or STL file. The assembly component data 182 can also include other features of each assembly component, e.g., a tensile strength of the materials of the assembly components. The assembly component data 182 can include data characterizing the instructions required to assemble the final products; for example, the data 182 can include the sequence of assembly steps, e.g., torque insertion operations, perpendicular insertion operations, rotation operations, etc.

After generating the robotic control plan 174, the planner 170 can provide the robotic control plan 174 to the robotic control system 150. The planner 170 can also provide initial component positions 172 of each robotic component 160n and assembly component in the robotic control plan 174 to the mobile automation setup device 120. The mobile automation setup device 120 can then instruct a user to place each assembly component into the corresponding initial position in the robotic operating environment 102.

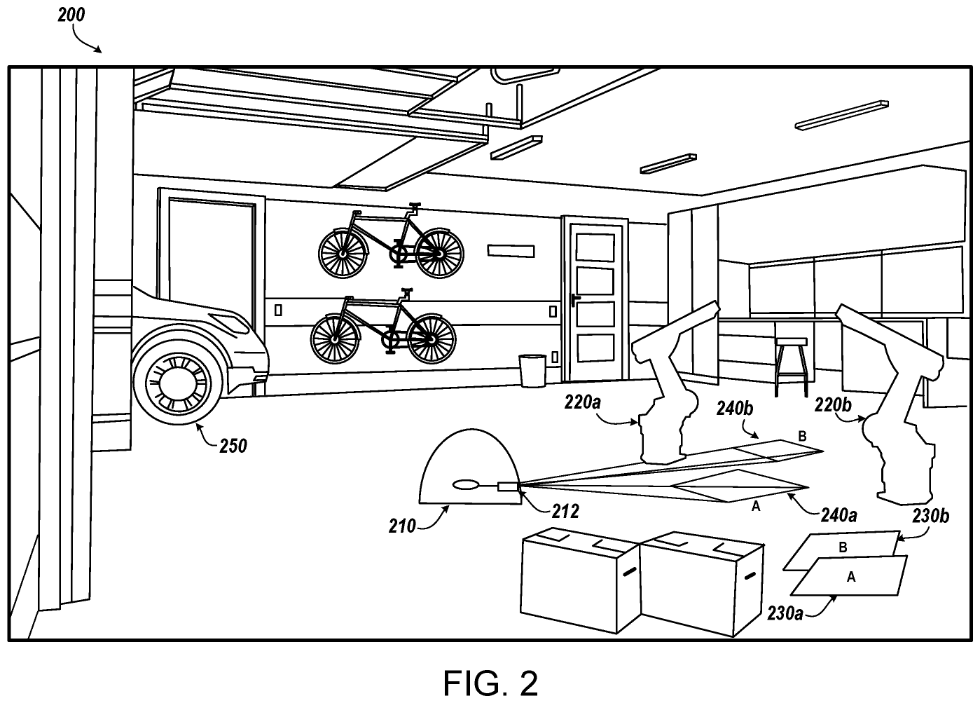

For example, the mobile automation setup device 120 can use the projection system 130 to provide instructions to the user. The projection system 130 of the mobile automation setup device 120 can include one or more devices that are configured to visually identify locations in the robotic operating environment 102, e.g., by projecting light onto the locations. For example, the projection system 130 can include one or more lasers. By projecting light at a particular location in the robotic operating environment 102, the mobile automation setup device 120 can direct the user to place an assembly component at the particular location before the execution of a robotic control plan 174. In some implementations, the mobile automation setup device 120 also instructs the user to place one or more robotic components 160a-n into the corresponding initial position. This process is discussed in more detail below with respect to FIG. 2.

As another example, the mobile automation setup device can instruct the user to place each component in the corresponding initial position in the robotic operating environment by displaying an image of the component and an identification of the corresponding initial position. The identification of the initial position of a component can be, for example, an image of the location captured by the sensor system 140, e.g., an image with an annotated outline of the initial position of the component. As a particular example, the mobile automation setup device 120 can be communicatively connected, e.g., through Wi-Fi, to a user device of the user, e.g., a mobile phone or tablet. The mobile automation setup device 120 can send data characterizing images of the components and identifications of the initial positions to the user device for display to the user, and the user device can display the information corresponding to each component in sequence. As another particular example, the mobile automation setup device 120 can include a display on which the images of the components and the identifications of the corresponding initial positions can be displayed for the user.

After instructing the user to place each component in the corresponding initial position, the mobile automation setup device 120 can confirm that each component is in the proper initial position. For example, the mobile automation setup device 120 can use the sensor system 140 to determine that each component is in the correct location and orientation within the robotic operating environment 102. As another example, the mobile automation setup device 120 can receive a user input, e.g., a voice command or graphical interface selection, confirming that the user has placed each component in the corresponding initial position.

In some implementations, after confirmation the placement of each component in the robotic operating environment 102, the mobile automation setup device 120 can obtain second sensor data of the robotic operating environment 102 using the sensor system 140 and process the second sensor data to ensure that the environment 102 has not changed and is ready to execute the robotic control plan 174.

After confirmation that the robotic operating environment 102 is ready, the mobile automation setup device 120 sends approval instructions 140 to the robotic control system 150. The robotic control system 150 can then execute the robotic control plan 174 by issuing commands 152 to the robotic components 160a-n in order to drive the movements of the robotic components 160a-n.

In some implementations, the planner 170 is an online planner. That is, the robotic control system 150 can receive the robotic control plan 174 and begin execution, and then provide feedback about the execution to the planner 170 during the execution. The planner 170 can then generate a new robotic control plan in response to the feedback. In some other implementations, the planner 170 is an offline planner. That is, the planner 170 can provide the robotic control plan 174 to the robotic control system 150 before the robotic control system 150 executes any operations, and the planner 170 does not receive any direct feedback from the robotic control system 150.

In some implementations, the robotic planning system is in the robotic operating environment; that is, the robotic control plan 174 can be generated by an on-site planner 170. In some other implementations, the robotic planning system 110 is hosted within an offsite data center, which can be a distributed computing system having hundreds or thousands of computers in one or more locations.

In some implementations, the robotic control system 150 is a component of the mobile automation setup device 120. In some other implementations, the robotic control system is hosted on one or more devices that are separate to the mobile automation setup device 120.

FIG. 2 illustrates an example robotic operating environment 200. The robotic operating environment 200 includes a mobile automation setup device 210, robotic components 220a-b, and assembly components 230a-b.

The robotic components 220a-b is configured to receive commands from a control system, e.g., the robotic control system 150 depicted in FIG. 1, to accomplish a task for assembling the assembly components 230a-b into a final product. The commands can be issued according to a robotic control plan generated by a planner, e.g. the planner 170 depicted in FIG. 1.

In order to generate the robotic control plan, the mobile automation setup device 210 can include one or more sensors that capture sensor data characterizing the robotic operating environment 200 and send the sensor data to a planner, e.g., the planner 170 depicted in FIG. 1.

In some implementations, the mobile automation setup device 210 can process the sensor data and generate a determination of whether the task is able to be accomplished in the robotic operating environment 200. For example, there may be one or more requirements that any robotic operating environment must meet in order for the robotic components 220a-b to be able to accomplish the task, e.g., a minimum volume of free space available. The mobile automation setup device 210 can process the sensor data to determine whether each minimum requirement is met, and notify the user if the task cannot be accomplished.

In some implementations, the mobile automation setup device 210 can use a projection system 212 to identify one or more objects in the robotic operating environment 200 and obtain input from a user about whether the one or more objects can be moved. For example, the mobile automation setup device might use the projection system 212 to project light onto the vehicle 250 and prompt the user, e.g., through an audio or visual prompt, to determine whether the vehicle 250 is movable. The user can then provide an input, e.g., a verbal input or a graphical interface input on a display of the mobile automation setup device 210, identifying whether the vehicle 250 is movable. As particular example, the mobile automation setup device might determine, using the obtained sensor data, that a minimum volume of space is not available in the robotic operating environment 200, and that removing the vehicle 250 would provide the minimum volume of space. If the user input clarifies that the vehicle 250 is movable, then the mobile automation setup device 210 can instruct the user to move the vehicle 250, and then capture second sensor data to confirm that the minimum volume of space is now available.

After the planner generates the robotic control plan for the robotic components 220a-b, the planner can provide initial positions for the assembly components 230a-b in the robotic operating environment 200 to the mobile automation setup device 210. The mobile automation setup device 210 can use the projection system 212 to project identifications 240a-b of the initial positions of the assembly components 230a-b, and prompt the user to position the assembly components 230a-b in the respective initial positions. In some implementations, the projection system 212 can project each identification 240a-b at once, as shown in FIG. 2. In some other implementations, the projection system 212 projects the identification 240a-b in sequence. That is, the projection system 212 can first project the identification 240a corresponding to the first assembly component 230a. After the user places the first assembly component 230a in its initial position, the mobile automation setup device 210 can determine that the first assembly component 230a has been placed. For example, the mobile automation setup device 210 can receive a user input, e.g., a verbal input, that the first assembly component 230a has been placed. As another example, the mobile automation setup device 210 can gather sensor data characterizing the initial position and process the sensor data to determine that that first assembly component 230a has been placed. After the determination, the projection system 212 can project the identification 240b corresponding to the second assembly component 230b, and so on.

In some implementations, the automation assistance can also project the initial positions of the robotic components 220a-b and instruct the user to place the robotic components 220a-b in the respective initial positions.

After each component in the robotic operating environment 200 has been placed in its initial position, the mobile automation setup device can provide approval instructions to the robotic control system to begin execution of the robotic control plan.

In some implementations, the mobile automation setup device 210 can act as a perception system during the execution of the robotic control plan. That is, the mobile automation setup device 210 can gather sensor data throughout the execution of the robotic control plan and process the sensor data to determine whether the robotic components 220a-b should continue the execution or whether there are issues. As a particular example, after the robotic components 220a-b assemble the first assembly component 230a into a certain configuration, the mobile automation setup device 210 can capture sensor data of the assembled first assembly component 230a and process the sensor data to determine whether it has been correctly assembled. If the mobile automation setup device 210 determines that the first assembly component 230a has been correctly assembled, the mobile automation setup device 210 can instruct the robotic control system to continue with the robotic control plan, e.g., to being adding the second assembly component 230b to the final product.

In some cases, the mobile automation setup device 210 might process the sensor data and determine that there is an issue with the execution of the robotic control plan, e.g., if a part has fallen off the product or if an assembly component is out of reach of the robotic components 220a-b. In some such implementations, the mobile automation setup device 210 might alert the planner to generate a new plan that addresses the new issue. In some implementations, the mobile automation setup device 210 might send a notification to the user, e.g., send a notification to a mobile device of the user. The mobile automation setup device 210 can then provide instructions for the user to address the new issue. After the user has addressed the issue, the mobile automation setup device 210 can capture new sensor data and confirm that the robotic control plan can continue.

In the implementations in which the mobile automation setup device 210 serves as a perception system during the execution of the robotic control plan, the mobile automation setup device can include itself in the sensor data provided to the planner before generating the robotic control plan. That is, because the mobile automation setup device 210 will be present during the execution of the robotic control plan, the sensor data must include the mobile automation setup device 210 so that the robotic control plan does not instruct the robotic components 220a-b to occupy the same space in the robotic operating environment 200 as the mobile automation setup device 210. In some implementation in which the mobile automation setup device 210 is not present during the execution of the robotic control plan, the mobile automation setup device 210 does not include itself in the sensor data, and can instruct the use to remove the mobile automation setup device 210 before the robotic components 220a-b begin executing the robotic control plan.

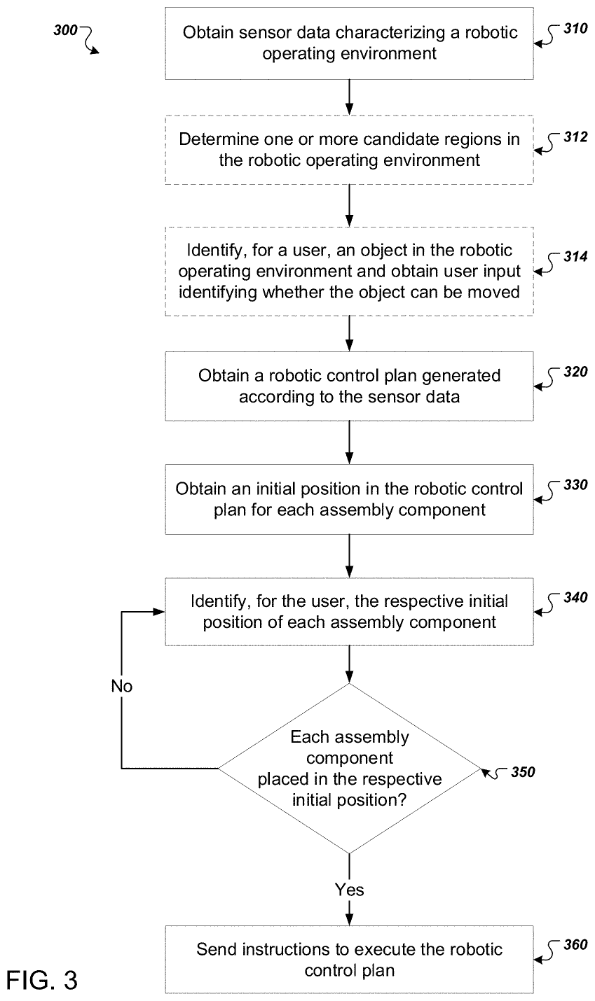

FIG. 3 is a flowchart of an example process 300 for generating a robotic control plan and preparing a robotic operating environment. The process 300 can be implemented by one or more computer programs installed on one or more computers and programmed in accordance with this specification. For example, the process 300 can be performed by the mobile automation setup device 120 depicted in FIG. 1. For convenience, the process 300 will be described as being performed by a system of one or more computers.

The system obtains sensor data characterizing a robotic operating environment (step 310). The robotic operating environment includes one or more assembly components. The sensor data can be captured by one or more LIDAR sensors, one or more cameras, and/or one or more ultrasonic sensors.

In some implementations, the system determine one or more candidate regions in the robotic operating environment (step 312). Each candidate region is a region in the robotic operating environment where one or more robotic components might execute a robotic control plan. For example, each candidate region might be a region that is large enough to include a template initial configuration that includes respective initial positions for each robotic component and each assembly component. The candidate regions can be used to generate the robotic control plan.

In some implementations, the system identifies, for a user, an object in the robotic operating environment and obtains user input identifying whether the object can be moved (step 314). For example, the system might project a laser on the object and prompt the user to provide the user input. The user input can be used to generate the robotic control plan, e.g., the planner that generates the robotic control plan can remove the sensor data characterizing the object from the sensor data and generate the robotic control plan as if the object were not in the robotic operating environment.

The system obtains a robotic control plan generated according to the sensor data (step 320). That is, the system can provide the sensor data to a planning system, e.g., the cloud computing planner 170 depicted in FIG. 1. The planning system can use the sensor data to generate the robotic control plan, and provide the robotic control plan back to the system. In some implementations, the robotic control plan has been generated using respective component data characterizing each of the one or more assembly components. In some implementations, the robotic control plan has been generated using assembly instructions identifying one or more steps for assembly the assembly components.

The system obtains a respective initial position for each assembly component in the robotic control plan (step 330). For example, the system can determine the initial positions from the robotic control plan. As another example, the system can receive the initial positions from the planning system that generated the robotic control plan.

The initial position in the robotic control plan for a particular assembly component can define a location and optionally an orientation in the robotic operating environment of the particular assembly component at the beginning of the execution of the robotic control plan. That is, the initial positions of each component in the robotic control plan defines how the robotic operating environment is configured before the start of the execution of the robotic control plan. For example, each assembly component can be placed on the floor of the robotic operating environment, e.g., the garage depicted in FIG. 2, within reach of the one or more robotic components that will interact with the assembly component.

The system identifies, for the user, the respective initial position for each assembly component (step 340). For example, the system can present a visual representation of the initial position for each assembly component. As a particular example, the system can visually indicate each initial position to the user using one or more lasers, e.g., by projecting, for each assembly component, an outline or other visual representation of the assembly component at the corresponding initial position. As another particular example, the system can display the initial position of each assembly component, e.g., displaying each initial position using a user device or a mobile automation setup device. For example, the system can display an image or sketch of the assembly component and an image of the corresponding initial position that was captured by the system. As another example, the system can display an image or sketch of the assembly component and a map of the robotic operating environment with a visual indication of the corresponding initial position. As another particular example, the system can generate a three-dimensional model of the robotic operating environment that includes representations of each assembly component in the corresponding initial position. The system can display the model of the robotic operating environment to the user, e.g., using a user device or a mobile automation setup assistant.

The user can use the identifications of the respective initial positions to place the assembly components in the correct initial positions.

In some implementations, the system also obtains a respective initial position for one or more robotic components, and identifies the initial positions for the one or more robotic components to the user so that the user can place the one or more robotic components in the correct initial positions.

The system determines whether each assembly component is placed in the respective initial position (step 350). For example, the system can obtain second sensor data characterizing the robotic operating environment and process the second sensor data to determine that each assembly component is placed in the corresponding initial position.

In response to determining that each assembly component is placed in the correct initial position, the system sends instructions to execute the robotic control plan (step 360). For example, the system can use a control system, e.g., the robotic control system 150 depicted in FIG. 1, to send commands to the robotic components in the robotic operating environment, where the commands are issued according to the robotic control plan.

If the system determines that one or more particular assembly components have not been placed in the correct initial position, the system can return to step 340 and identify the respective initial positions of the particular assembly components to the user again.

In some implementations, during the execution of the robotic control plan, the system obtains third sensor data characterizing the robotic operating environment. The system can then determine, for each of one or more second assembly component, a desired position of the second assembly component in the robotic control plan. The second assembly components can include one or more of the original assembly components in the robotic operating environment. Instead or in addition, the second assembly components can include assembly components that have been assembly using one or more of the original assembly components in the robotic operating environment. The robotic control plan can define, for each of the second assembly components and for the current time point in the execution of the robotic control plan, a respective desired position.

The system can process the third sensor data to determine, for each second assembly component, that the second assembly component is placed in the corresponding desired position. If the system determines that one or more particular second assembly components are not placed in the corresponding desired position, the system can send instructions to the robotic control system to stop execution of the robotic control plan. In some case, the system can instruct the planner to generate a new plan that accounts for the different position of the one or more particular second assembly components. In some other cases, the system can notify the user to enter to the robotic operating environment and position the one or more particular second assembly components in the corresponding desired positions.

The robot functionalities described in this specification can be implemented by a hardware-agnostic software stack, or, for brevity just a software stack, that is at least partially hardware-agnostic. In other words, the software stack can accept as input commands generated by the planning processes described above without requiring the commands to relate specifically to a particular model of robot or to a particular robotic component. For example, the software stack can be implemented at least partially by the robotic control system 150 of FIG. 1.

The software stack can include multiple levels of increasing hardware specificity in one direction and increasing software abstraction in the other direction. At the lowest level of the software stack are robot components that include devices that carry out low-level actions and sensors that report low-level statuses. For example, robotic components can include a variety of low-level components including motors, encoders, cameras, drivers, grippers, application-specific sensors, linear or rotary position sensors, and other peripheral devices. As one example, a motor can receive a command indicating an amount of torque that should be applied. In response to receiving the command, the motor can report a current position of a joint of the robot, e.g., using an encoder, to a higher level of the software stack.

Each next highest level in the software stack can implement an interface that supports multiple different underlying implementations. In general, each interface between levels provides status messages from the lower level to the upper level and provides commands from the upper level to the lower level.

Typically, the commands and status messages are generated cyclically during each control cycle, e.g., one status message and one command per control cycle. Lower levels of the software stack generally have tighter real-time requirements than higher levels of the software stack. At the lowest levels of the software stack, for example, the control cycle can have actual real-time requirements. In this specification, real-time means that a command received at one level of the software stack must be executed and optionally, that a status message be provided back to an upper level of the software stack, within a particular control cycle time. If this real-time requirement is not met, the robot can be configured to enter a fault state, e.g., by freezing all operation.

At a next-highest level, the software stack can include software abstractions of particular components, which will be referred to motor feedback controllers. A motor feedback controller can be a software abstraction of any appropriate lower-level components and not just a literal motor. A motor feedback controller thus receives state through an interface into a lower-level hardware component and sends commands back down through the interface to the lower-level hardware component based on upper-level commands received from higher levels in the stack. A motor feedback controller can have any appropriate control rules that determine how the upper-level commands should be interpreted and transformed into lower-level commands. For example, a motor feedback controller can use anything from simple logical rules to more advanced machine learning techniques to transform upper-level commands into lower-level commands. Similarly, a motor feedback controller can use any appropriate fault rules to determine when a fault state has been reached. For example, if the motor feedback controller receives an upper-level command but does not receive a lower-level status within a particular portion of the control cycle, the motor feedback controller can cause the robot to enter a fault state that ceases all operations.

At a next-highest level, the software stack can include actuator feedback controllers. An actuator feedback controller can include control logic for controlling multiple robot components through their respective motor feedback controllers. For example, some robot components, e.g., a joint arm, can actually be controlled by multiple motors. Thus, the actuator feedback controller can provide a software abstraction of the joint arm by using its control logic to send commands to the motor feedback controllers of the multiple motors.

At a next-highest level, the software stack can include joint feedback controllers. A joint feedback controller can represent a joint that maps to a logical degree of freedom in a robot. Thus, for example, while a wrist of a robot might be controlled by a complicated network of actuators, a joint feedback controller can abstract away that complexity and exposes that degree of freedom as a single joint. Thus, each joint feedback controller can control an arbitrarily complex network of actuator feedback controllers. As an example, a six degree-of-freedom robot can be controlled by six different joint feedback controllers that each control a separate network of actual feedback controllers.

Each level of the software stack can also perform enforcement of level-specific constraints. For example, if a particular torque value received by an actuator feedback controller is outside of an acceptable range, the actuator feedback controller can either modify it to be within range or enter a fault state.

To drive the input to the joint feedback controllers, the software stack can use a command vector that includes command parameters for each component in the lower levels, e.g., a positive, torque, and velocity, for each motor in the system. To expose status from the joint feedback controllers, the software stack can use a status vector that includes status information for each component in the lower levels, e.g., a position, velocity, and torque for each motor in the system. In some implementations, the command vectors also include some limit information regarding constraints to be enforced by the controllers in the lower levels.

At a next-highest level, the software stack can include joint collection controllers. A joint collection controller can handle issuing of command and status vectors that are exposed as a set of part abstractions. Each part can include a kinematic model, e.g., for performing inverse kinematic calculations, limit information, as well as a joint status vector and a joint command vector. For example, a single joint collection controller can be used to apply different sets of policies to different subsystems in the lower levels. The joint collection controller can effectively decouple the relationship between how the motors are physically represented and how control policies are associated with those parts. Thus, for example if a robot arm has a movable base, a joint collection controller can be used to enforce a set of limit policies on how the arm moves and to enforce a different set of limit policies on how the movable base can move.

At a next-highest level, the software stack can include joint selection controllers. A joint selection controller can be responsible for dynamically selecting between commands being issued from different sources. In other words, a joint selection controller can receive multiple commands during a control cycle and select one of the multiple commands to be executed during the control cycle. The ability to dynamically select from multiple commands during a real-time control cycle allows greatly increased flexibility in control over conventional robot control systems.

At a next-highest level, the software stack can include joint position controllers. A joint position controller can receive goal parameters and dynamically compute commands required to achieve the goal parameters. For example, a joint position controller can receive a position goal and can compute a set point for achieve the goal.

At a next-highest level, the software stack can include Cartesian position controllers and Cartesian selection controllers. A Cartesian position controller can receive as input goals in Cartesian space and use inverse kinematics solvers to compute an output in joint position space. The Cartesian selection controller can then enforce limit policies on the results computed by the Cartesian position controllers before passing the computed results in joint position space to a joint position controller in the next lowest level of the stack. For example, a Cartesian position controller can be given three separate goal states in Cartesian coordinates x, y, and z. For some degrees, the goal state could be a position, while for other degrees, the goal state could be a desired velocity.

These functionalities afforded by the software stack thus provide wide flexibility for control directives to be easily expressed as goal states in a way that meshes naturally with the higher-level planning techniques described above. In other words, when the planning process uses a process definition graph to generate concrete actions to be taken, the actions need not be specified in low-level commands for individual robotic components. Rather, they can be expressed as high-level goals that are accepted by the software stack that get translated through the various levels until finally becoming low-level commands. Moreover, the actions generated through the planning process can be specified in Cartesian space in way that makes them understandable for human operators, which makes debugging and analyzing the schedules easier, faster, and more intuitive. In addition, the actions generated through the planning process need not be tightly coupled to any particular robot model or low-level command format. Instead, the same actions generated during the planning process can actually be executed by different robot models so long as they support the same degrees of freedom and the appropriate control levels have been implemented in the software stack.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:

obtaining, by a mobile automation setup device, sensor data characterizing a robotic operating environment, wherein the robotic operating environment comprises one or more assembly components;

providing, by the mobile automation setup device, the sensor data to a robotic planning system;

receiving, by the mobile automation setup device from the robotic planning system, a robotic control plan to be executed by one or more robotic components in the robotic operating environment, wherein the robotic control plan has been generated according to the obtained sensor data;

obtaining, by the mobile automation setup device and for each assembly component, a respective initial position of the assembly component in the robotic control plan; and

presenting a visual representation of the respective initial position for each of the one or more assembly components.

Embodiment 2 is the method of embodiment 1, wherein presenting a visual representation of the initial position of an assembly component comprises visually indicating the initial position to the user using one or more lasers.

Embodiment 3 is the method of any one of embodiments 1 or 2, wherein presenting a visual representation of the initial position of an assembly component comprises displaying an identification of the initial position on the mobile automation setup device or on a user device.

Embodiment 4 is the method of any one of embodiments 1-3, further comprising:

determining, for each assembly component, that the assembly component is placed in the initial position of the assembly component; and

in response to determining that each assembly component is placed in the respective initial position, sending instructions for the one or more robotic components to execute the robotic control plan.

Embodiment 5 is the method of embodiment 4, wherein determining that an assembly component is placed in the corresponding initial position comprises:

obtaining second sensor data characterizing the robotic operating environment; and

processing the second sensor data to determine that the assembly component is placed in the corresponding initial position.

Embodiment 6 is the method of any one of embodiments 1-5, further comprising:

obtaining, by the mobile automation setup device and for each robotic component, a respective initial position of the robotic component in the robotic control plan;

presenting a visual representation of the respective initial position for each of the one or more robotic components.

Embodiment 7 is the method of any one of embodiments 1-6, wherein the sensor data is captured by one or more sensors, wherein the one or more sensors comprise one or more of:

one or more LIDAR sensors;

one or more cameras; or

one or more ultrasonic sensors.

Embodiment 8 is the method of any one of embodiments 1-7, wherein generating the robotic control plan comprises:

obtaining, for each of the one or more assembly components, component data characterizing the assembly component; and

obtaining assembly instructions identifying one or more steps for assembling the assembly components.

Embodiment 9 is the method of any one of embodiments 1-8, wherein providing the sensor data to the robotic planning system comprises determining, using the obtained sensor data, one or more candidate regions, wherein each candidate region is a region in the robotic operating environment where the one or more robotic components might execute the robotic control plan.

Embodiment 10 is the method of any one of embodiments 1-9, further comprising:

identifying, for the user, an object in the robotic operating environment; and

obtaining a user input identifying whether the object can be moved,

wherein the robotic control plan has been generated according to the user input.

Embodiment 11 is the method of any one of embodiments 1-10, further comprising:

obtaining, during the execution of the robotic control plan, third sensor data characterizing the robotic operating environment;

determining, for each of one or more second assembly components, a desired position of the second assembly component in the robotic control plan; and

processing the third sensor data to determine, for each second assembly component, that the second assembly component is placed in the corresponding desired position.

Embodiment 12 is the method of any one of embodiments 1-11, wherein the robotic operating environment is a temporary robotic operating environment.

Embodiment 13 is a system comprising: one or more computers and one or more storage devices storing instructions that are operable, when executed by the one or more computers, to cause the one or more computers to perform the method of any one of embodiments 1 to 12.

Embodiment 14 is a computer storage medium encoded with a computer program, the program comprising instructions that are operable, when executed by data processing apparatus, to cause the data processing apparatus to perform the method of any one of embodiments 1 to 12.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A method comprising:
obtaining, by a mobile automation setup device, sensor data characterizing a robotic operating environment, wherein the robotic operating environment comprises one or more assembly components;
providing, by the mobile automation setup device, the sensor data to a robotic planning system;
receiving, by the mobile automation setup device from the robotic planning system, a robotic control plan to be executed by one or more robotic components in the robotic operating environment, wherein the robotic control plan has been generated according to the obtained sensor data;
obtaining, by the mobile automation setup device and for each assembly component, a respective initial position of the assembly component in the robotic control plan; and
presenting a visual representation of the respective initial position for each of the one or more assembly components.

2. The method of claim 1, wherein presenting a visual representation of the initial position of an assembly component comprises visually indicating the initial position to the user using one or more lasers.

3. The method of claim 1, wherein presenting a visual representation of the initial position of an assembly component comprises displaying an identification of the initial position on the mobile automation setup device or on a user device.

4. The method of claim 1, further comprising:
determining, for each assembly component, that the assembly component is placed in the initial position of the assembly component; and
in response to determining that each assembly component is placed in the respective initial position, sending instructions for the one or more robotic components to execute the robotic control plan.

5. The method of claim 4, wherein determining that an assembly component is placed in the corresponding initial position comprises:
obtaining second sensor data characterizing the robotic operating environment; and
processing the second sensor data to determine that the assembly component is placed in the corresponding initial position.

6. The method of claim 1, further comprising:
obtaining, by the mobile automation setup device and for each robotic component, a respective initial position of the robotic component in the robotic control plan;
presenting a visual representation of the respective initial position for each of the one or more robotic components.

7. The method of claim 1, wherein the sensor data is captured by one or more sensors, wherein the one or more sensors comprise one or more of:
one or more LIDAR sensors;
one or more cameras; or
one or more ultrasonic sensors.

8. The method of claim 1, wherein generating the robotic control plan comprises:
obtaining, for each of the one or more assembly components, component data characterizing the assembly component; and
obtaining assembly instructions identifying one or more steps for assembling the assembly components.

9. The method of claim 1, wherein providing the sensor data to the robotic planning system comprises determining, using the obtained sensor data, one or more candidate regions, wherein each candidate region is a region in the robotic operating environment where the one or more robotic components might execute the robotic control plan.

10. The method of claim 1, further comprising:
identifying, for the user, an object in the robotic operating environment; and
obtaining a user input identifying whether the object can be moved,
wherein the robotic control plan has been generated according to the user input.

11. The method of claim 1, further comprising:
obtaining, during the execution of the robotic control plan, third sensor data characterizing the robotic operating environment;
determining, for each of one or more second assembly components, a desired position of the second assembly component in the robotic control plan; and
processing the third sensor data to determine, for each second assembly component, that the second assembly component is placed in the corresponding desired position.

12. The method of claim 1, wherein the robotic operating environment is a temporary robotic operating environment.

13. A system comprising one or more computers and one or more storage devices storing instructions that are operable, when executed by the one or more computers, to cause the one or more computers to perform operations comprising:
obtaining, by a mobile automation setup device, sensor data characterizing a robotic operating environment, wherein the robotic operating environment comprises one or more assembly components;
providing, by the mobile automation setup device, the sensor data to a robotic planning system;
receiving, by the mobile automation setup device from the robotic planning system, a robotic control plan to be executed by one or more robotic components in the robotic operating environment, wherein the robotic control plan has been generated according to the obtained sensor data;
obtaining, by the mobile automation setup device and for each assembly component, a respective initial position of the assembly component in the robotic control plan; and
presenting a visual representation of the respective initial position for each of the one or more assembly components.

14. The system of claim 13, wherein the operations further comprise:
determining, for each assembly component, that the assembly component is placed in the initial position of the assembly component; and
in response to determining that each assembly component is placed in the respective initial position, sending instructions for the one or more robotic components to execute the robotic control plan.

15. The system of claim 13, wherein the operations further comprise:
identifying, for the user, an object in the robotic operating environment; and
obtaining a user input identifying whether the object can be moved,
wherein the robotic control plan has been generated according to the user input.

16. The system of claim 13, wherein the robotic operating environment is a temporary robotic operating environment.

17. One or more non-transitory storage media storing instructions that when executed by one or more computers cause the one or more computers to perform operations comprising:
obtaining, by a mobile automation setup device, sensor data characterizing a robotic operating environment, wherein the robotic operating environment comprises one or more assembly components;
providing, by the mobile automation setup device, the sensor data to a robotic planning system;
receiving, by the mobile automation setup device from the robotic planning system, a robotic control plan to be executed by one or more robotic components in the robotic operating environment, wherein the robotic control plan has been generated according to the obtained sensor data;
obtaining, by the mobile automation setup device and for each assembly component, a respective initial position of the assembly component in the robotic control plan; and
presenting a visual representation of the respective initial position for each of the one or more assembly components.

18. The non-transitory storage media of claim 17, wherein the operations further comprise:
determining, for each assembly component, that the assembly component is placed in the initial position of the assembly component; and
in response to determining that each assembly component is placed in the respective initial position, sending instructions for the one or more robotic components to execute the robotic control plan.

19. The non-transitory storage media of claim 17, wherein the operations further comprise:
identifying, for the user, an object in the robotic operating environment; and
obtaining a user input identifying whether the object can be moved,
wherein the robotic control plan has been generated according to the user input.

20. The non-transitory storage media of claim 17, wherein the robotic operating environment is a temporary robotic operating environment.
